(19) United States
(12) Patent Application Publication
(10) Pub. No.: US 2019/0094019 A1
(43) Pub. Date: Mar. 28, 2019

(54) DEVICE FOR MEASURING AT LEAST ONE DISTANCE-RELATED PARAMETER WITH RESPECT TO AT LEAST ONE TARGET SURFACE

(71) Applicants: Oz Cohen, Modi'in (IL); Yosef Biksenspaner, Nes Ziona (IL)

(72) Inventors: Oz Cohen, Modi'in (IL); Yosef Biksenspaner, Nes Ziona (IL)

(21) Appl. No.: 16/130,379

(22) Filed: Sep. 13, 2018

Related U.S. Application Data
(60) Provisional application No. 62/563,936, filed on Sep. 27, 2017.

(51) Int. Cl. G01B 21/04; G01B 21/16; G01B 21/28

(52) U.S. Cl. CPC G01B 21/047; G01C 3/18; G01B 21/28; G01B 21/16

(57) ABSTRACT

A device for measuring at least a distance from one or more target surfaces is provided. The device comprises at least two measuring members connected to each other so as to perform a pivotal movement about a common pivot axis passing through and perpendicular to a pivot plane of each measuring member. Its longitudinal axis lies in any angular position of the measuring member with respect to the pivot axis which is disposed closer to proximal ends of the measuring members than their distal ends. The device further comprises at least one distance sensor at each of the two measuring members, positioned so that its line of sight is transverse to a reference plane perpendicular to the pivot plane and passing through the longitudinal axis. The sensor is configured for producing a signal indicative of the distance between the sensor and a target surface.

### CROSS-REFERENCE TO RELATED APPLICATIONS

Priority is claims from U.S. provisional application No. 62/563,936 filed Sep. 27, 2017, the contents and disclosure of which is incorporated herein, in its entirety, by reference.

### TECHNOLOGICAL FIELD

The presently disclosed subject matter relates to pocket held measuring devices for measuring at least one distance-related parameter with respect to at least one target surface.

### BACKGROUND

Devices of the kind, to which the presently disclosed subject matter refers, are disclosed, for example, in CN201716415, CN2938030, JP2004177207 and CN2938030.

### GENERAL DESCRIPTION

According to the presently disclosed subject matter there is provided a device for measuring at least a distance from one or more target surfaces, said device comprising:
at least two measuring members each having a distal end and a proximal end spaced from each other along a longitudinal axis of the measuring member, said two measuring members being connected to each other so as to be able to perform pivotal movement about a common pivot axis passing through and perpendicular to a pivot plane of each measuring member, in which its longitudinal axis lies in any angular position of the measuring member with respect to the pivot axis, the pivot axis being disposed closer to the proximal ends of the measuring members than to their distal ends; and
at least one distance sensor at each of the two measuring members, positioned so that its line of sight is transverse to a reference plane perpendicular to said pivot plane and passing through said longitudinal axis, said sensor being configured for producing a signal indicative of the distance between the sensor and a target surface;
   wherein said device is manipulable by pivoting the measuring members relative to each other about the pivot axis, at least between an open state, in which the reference planes of the two measuring members create therebetween an angle greater than 90°, optionally greater than 150°, and a folded state, in which these reference planes create therebetween an angle smaller than 90°, optionally smaller than 30°.

The signal/s provided by the device as defined above can be used to determine remotedly at least one of the following distance-related parameters: parallelity of at least one target surface to a portion of at least one of the measuring members; angle between at least one target surface and a portion of at least one of the measuring members; angle between two target surfaces; spatial location of a pre-determined area on at least one of the measuring members in relation to at least one target surface; distance between two distal points spaced from each other and located on one or two target surfaces; or the like.

In the above device, at least one of the sensors can be positioned at a location of the measuring member closer to the distal end than to the proximal end of the measuring member.

The device can further comprise at least one processing unit configured for receiving and processing the signals from the distance sensors of the measuring members, and an indicator configured for producing at least one reading based on the processed signals. The at least one reading can relate to one or more of the following: parallelity of at least one target surface to a portion of at least one of the measuring members; angle between at least one target surface and a portion of at least one of the measuring members; angle between two target surfaces; spatial location of a pre-determined area on at least one of the measuring members in relation to at least one target surface; distance between two distal points spaced from each other and located on one or two target surfaces; or the like. The device can further comprise a user interface allowing a user to choose a kind of reading to be produced on said indicator. The reading can have any appropriate form, e.g. it can be visual and/or vocal.

The device can further comprise an angle meter configured for producing a signal indicative of an angle between the reference planes of the two measuring members. The distance sensors can be in the form of any one or more of the following: ultrasonic sensors, laser based sensors, IR based sensors, etc.

The device can further comprise at least one of the following auxiliary devices: a magnometer configured for detecting metals undersurface; a marker configured for marking visual markings upon a rough surface; a spirit level configured to indicate whether the longitudinal axes of the measuring members are horizontal; a gyrocompass configured for producing a signal indicative of a geographic direction of at least one of the earth's poles. In the latter case, the indicator mentioned above can be further configured to produce a reading relating to said geographic direction of at least one of the earth's poles.

### BRIEF DESCRIPTION OF THE DRAWINGS

In order to better understand the subject matter that is disclosed herein and to exemplify how it can be carried out in practice, embodiments will now be described, by way of non-limiting example only, with reference to the accompanying drawings, in which:

FIG. 1 is a perspective view of a device according to one example of the presently disclosed subject matter;

FIG. 2A is a plan view of the device shown in FIG. 1 in its maximally open state;

FIG. 2B is a plan view of the device shown in FIG. 1 in its maximally closed, folded state;

FIG. 3 illustrates the device shown in FIGS. 1 to 2B, when used for determining parrallelity of a target surface to one measurement area of the device and a distance therebetween;

FIG. 4 illustrates the device shown in FIGS. 1 to 2B when used for determining distances thereto from two target surfaces angled with respect to each other;

FIG. 5 illustrates the device shown in FIG. 1 when used for determining distances from the measurement surfaces of the device to two opposite target surfaces;

FIG. 6A illustrates a device according to another example of the presently disclosed subject matter, when used for determining remotely an angle between two angled target surfaces remotely, and for determining the distance between two distal points spaced from each other and located on one or two target surfaces; and

FIG. 6B illustrates a device according to another example of the presently disclosed subject matter shown when used for determining directly an angle between two angled target surfaces.

### DETAILED DESCRIPTION OF EMBODIMENTS

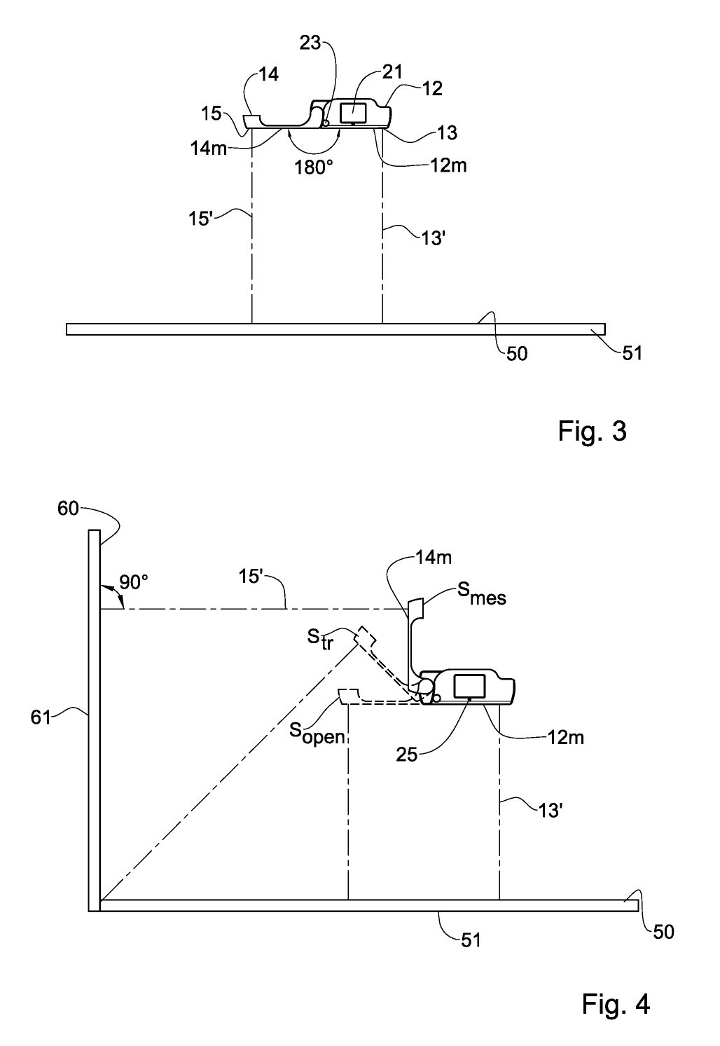

Devices according to the presently disclosed subject matter can be used for measuring one or more distance-related parameters with respect to one or more target surfaces, such as a target surface 50 shown in FIG. 3, and target surfaces 50 and 60 shown in FIG. 4, which can constitute inner surfaces of walls 51 and 61 of a typical house.

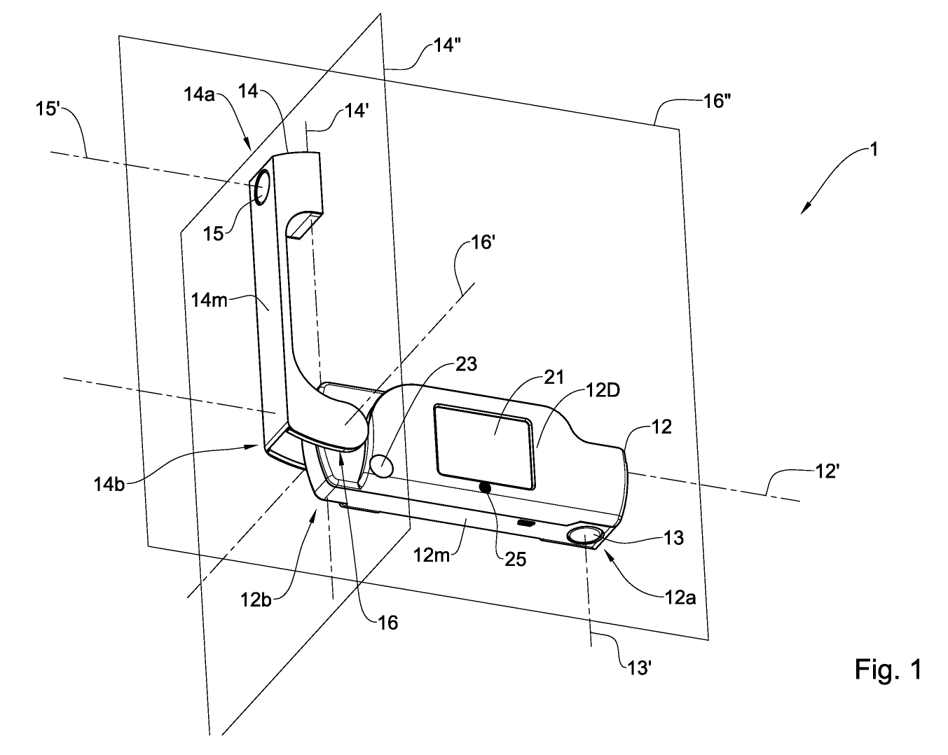

One such device designated as 1 is illustrated in FIG. 1, where it is shown to comprise two measuring members 12 and 14, each having a distal end 12a, 14a and a proximal end 12b, 14b, respectively, spaced from each other along a longitudinal axis 12′, 14′ of their respective measuring member.

The two measuring members 12 and 14 are connected to each other so as to be able to perform a pivotal movement relative to each other about a common pivot axis 16′ oriented perpendicularly to a pivot plane of each measuring member, in which its longitudinal axis 12′, 14′ lies in any angular position of the measuring member 12, 14 about the pivot axis 16′, whereas the pivot axis 16′ is disposed closer to the proximal ends 12b and 14b of the measuring members than to their distal ends 12a and 14a.

In the embodiment illustrated in FIG. 1, the two measuring members 12 and 14 share the same pivot plane, designated as 16″, in which their respective longitudinal axes lie, and are articulated to each other via a hinge 16, allowing them to perform the relative pivotal movement about the pivot axis 16′ passing through the center of the hinge. As illustrated, in this embodiment the pivot axis 16′ is perpendicular to the pivot plane 16″ of the measuring members.

Each measuring member 12, 14 further has its measurement reference plane 12″, 14″, which is perpendicular to the pivot plane 16″ and passes through the longitudinal axis 12′, 14′ of the measuring member, respectively. In FIG. 1, only the reference plane 14″ of the measuring member 14 is shown.

Each measuring member 12, 14 has a body having an exterior defined by its outer surfaces including a planar measurement area 12_{M}, 14_{M}, whose orientation relative to the longitudinal axis 12′, 14′ of the measuring member and to the pivot axis 16′ of the two members is pre-determined. In the embodiment of FIG. 1, the measurement area 12_{M}, 14_{M} of each member is parallel to the measurement reference plane 12″, 14″ thereof.

Each of the measuring members 12, 14 further comprises at least one distance sensor designated as 13, 15 in the embodiment of FIG. 1, and having a line of sight 13′, 15′, respectively. Each of the sensors 13 and 15 can be a laser based sensor, e.g. an IR laser based sensor, an ultrasonic sensor, or any other type of sensor configured for producing a distance signal indicative of the distance between the sensor and one target surface, towards which it is directed. The two sensors can be of the same or different types.

In other embodiments of the presently disclosed subject matter, at least one of the measuring members can comprise more than one distance sensors, and/or at least one additional sensor other than the distance sensor.

Each sensor can be configured for producing an instantaneous distance signal, related to an instantaneous measurement of distance, or an ongoing distance signal, which can be related to either a continuous measurement or to a series of instantaneous measurements performed by the sensor.

In general, the sensors 13 and 15 can be positioned anywhere along the longitudinal dimension of the measuring members, though in the embodiment of FIG. 1, the sensors 13 and 14 are positioned at a location of their respective measuring member 12, 14 closer to its distal end 12a, 14a than to its proximal end 12b, 14b.

Furthermore, in general the lines of sight 13′ and 15′ of the sensors 13 and 15 are oriented transversely to the measurement reference plane 12″, 14″ of the respective measuring member, forming therewith a pre-determined angle greater than zero, more particularly, greater than 45 degrees. In the embodiment illustrated in FIG. 1, this angle is 90° degrees, and also the sensor's lines of sight are also oriented at a 90° angle to the measurement area 12_{M}, 14_{M}, of the measuring member 12, 14.

In general, the device 1 can be manipulable by pivoting the measuring members 12 and 14 relative to each other about the pivot axis 16′, at least between a maximally open state of the device, in which the reference planes 12″ and 14″ of the measuring members create therebetween a pre-determined maximal angle greater than 90°, particularly greater than 150°, and still more particularly close or equal to 180° as in the embodiment of FIG. 1, and a maximally closed or folded state of the device, in which the reference planes 12″ and 14″ create therebetween a pre-determined minimal angle smaller than 90°, particularly smaller than 30°, and still more particularly close or equal to zero, as in the embodiment of FIG. 1.

As mentioned above, the minimal and maximal angles between the measurement reference planes of the measuring members in the maximally open and maximally closed states of the device, are pre-determined, i.e. they are defined by the structure of the device, which can have restriction means for preventing the measuring members to assume in the above states, angles other than the pre-determined minimal and maximal angles. Other predetermined parameters characterizing the device at each of the states are the position of the sensors in relation to the pivot axis, and the orientation of their lines of sight. All these pre-determined parameters can be fed to the processing unit in advance.

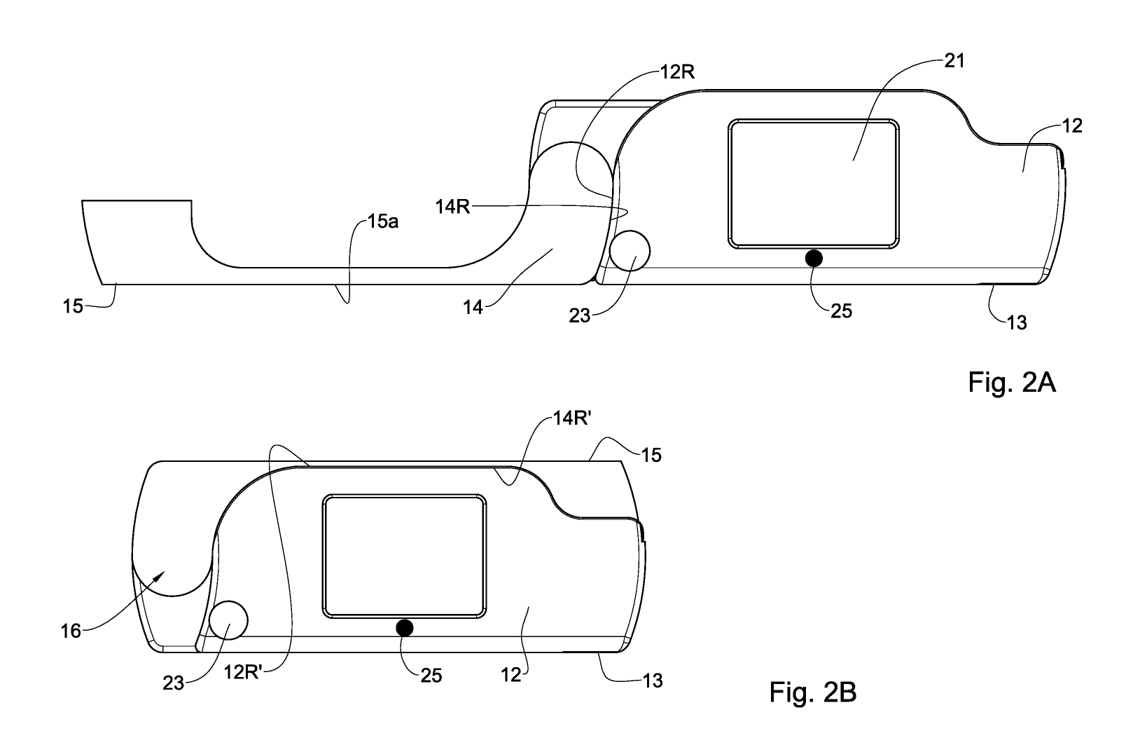

FIG. 2A illustrates the device 1 in its maximally open state Sₒₚₑₙ, in which its two measuring members 12 and 14 (namely their two reference planes—not shown in FIG. 2A) define the angle of 180° in relation to each other, and their longitudinal axes (not shown in FIG. 2A) in this state are aligned. FIG. 2B shows the device 1 in its maximally closed or folded state S_{fold}, in which its two measuring members 12 and 14 (namely their two reference planes—not shown in FIG. 2A) define the angle of 0° in relation to each other, and their longitudinal axes (not shown in FIG. 2A) in this state are parallel yet not aligned.

As seen in FIG. 2A, the lines of sight 13′ and 15′ of the sensors 13 and 15 of the measuring members are disposed perpendicularly to the longitudinal axes 12′,14′ of the corresponding measuring members.

To prevent the measuring members from further pivoting relative to each other after the above maximal angle has been reached, when the device 1 is brought from its folded state to its maximally open state, the device 1 can be formed with mechanical restriction arrangement, which in the embodiment of FIG. 1, is in the form of a restricting wall 12R of the measuring member 12 and a restricted wall 14R of the measuring member 14. The structure of the measuring members and their walls 12R and 14R is such the walls abut each other when the above maximal angle has been reached. Similar mechanical restriction arrangement can be provided preventing the measuring members from further pivoting relative to each other when the minimal pre-determined angle therebetween is reached when the device 1 is brought from its open state to its folded state. In the embodiment of FIG. 1, this arrangement is in the form of a restricting wall 12R′ of the measuring member 12 and a restricted wall 14R′ of the measuring member 14. The structure of the measuring members and their walls 12R′ and 14R′ is such the walls abut each other when the above minimal angle has been reached.

As an alternative to the restriction means, or in addition thereto, a device according to the presently disclosed subject matter can further comprise an angle meter, for indicating the exact angle between the measuring members, i.e. their reference planes, so that a user will be able to determine when the device is exactly at one of its states by looking at the reading from the angle meter.

The device according to the presently disclosed subject matter can comprise at least one processing unit mounted within at least one of the measuring members or disposed remotely (not shown), configured for receiving and processing distance signals from the sensors, and an indicator configured for producing at least one reading based on the processed signals. The indicator can be visual or vocal, and can be in the form of a display configured for producing visual readings of any format, a color bar, a speaker configured for producing vocal readings, or any other means configured for producing a well-defined reading based on the processed signals

In the device 1 of the embodiment shown in FIG. 1, the indicator is constituted by a display 21 disposed at a display surface 12_{D} of the measuring member 12, and configured for producing a visual reading, e.g. a numerical reading, based on the processed distance signals produced by the distance sensors 13 and 15 and processed by the processing unit. Thus, the display 21 can be configured for producing readings from the two distance sensors 15 and 13, simultaneously. The distance reading can change continuously when one of the sensors is performing a continuous measurement. In embodiments of the device that allow different readings to be produced on one indicator, a user interface can be incorporated in the device, allowing a user to choose the kind of reading to be produced on the indicator. This can be done, for example, by using a button such as a button 23 of device 1. In the embodiment illustrated in FIG. 1, the display 21, the button 23 and the processing unit (which is not seen) are all incorporated in the measuring member 12, which in this case can be considered as a main member.

The processing unit can be configured for comparing distance signals received from different distance sensors so as to produce a processed signal related to parameters other than the distance between each sensors and a respective target surface.

The processing unit can receive its distance signals from the sensor 15 of the measuring member 14 via Bluetooth communication or via wires passing through the hinge 16 or in the vicinity of the hinge.

FIG. 3 illustrates the device 1 described above, when used for determining parrallelity of the measurement areas 12_{M} and 14_{M} of its measuring members 12 and 14, and the inner surface 50 of the wall 51, and a distance therebetween.

As shown in FIG. 3, the device 1 is used in its maximally open state Sₒₚₑₙ, in which the lines of sight 13′ and 15′ of the sensors 13 and 15 are parallel to each other, and the device is so oriented with respect to the target surface 50 that the lines of sight 13′ and 15′ intersect the target surface to allow the distance sensors 13 and 15 to provide comparable distance signals indicative of the distances between each of the sensors and the target surface 50. The processing unit is thus configured for comparing, using simple mathematical computations that are well known to a person skilled in the art, while taking in consideration the other known predetermined parameters, these distance signals from the two sensors to determine the distance between the target surface 50 and the sensors 13 and 15, and to determine whether the target surface 50 is parallel to the measurement areas 12_{M} and 14_{M}.

Following this computation, a parallelity signal can be produced by the processing unit and be illustrated by the indicator, i.e. it can be displayed as a parallelity reading on the display 21. The signal can be a numerical signal indicating the extent to which the target surface is far from being parallel to the measurement areas of the device 1. This parallelity reading can be displayed together with the distance reading.

FIG. 4 illustrates the use of the device 1 described above for determining distances therefrom to two target surfaces, 50 and 60, which are both straight, which belong to two walls 51 and 61 oriented at an angle with respect to each other.

As shown, initially, the device 1 is positioned at its maximally open state Sₒₚₑₙ, and so that its measurement surfaces 12_{M} and 14_{M} are parallel to the target surface 50. This parallelity can be achieved in the manner described with reference to FIG. 3. After the measurement area 12_{M} is determined to be parallel to the target surface 50, user switches the type of reading on the display 21, using the button 23 so that the display 21 will produce a reading indicative of the distance between the target surface 50 and the sensors sensor 13 and 15, and this distance reading can be displayed together with the parallelity reading mentioned above.

After making sure that the distance reading is displayed on the display 21, the user can start pivoting the measuring member 14 about the pivot axis 16′ [not shown] while keeping the measuring member 12 fixed at its position parallel to the target surface 50, for example by holding it against a fixed surface such as a celling or a floor. During the pivoting process the user can watch the display 21 and follow the change in the distance reading relating to the sensor 15, as it moves with measuring member 14. It is expected that in the first moments of pivoting, as long as the sensor's line of sight 15′ intersects with the target surface 50, the changing distance readings relating to the sensor 15 will reflect an increase in the distance between this sensor and the target surface 50.

As the user continues pivoting the measuring member 14 about the pivot axis 16′, it reaches a point where the line of sight 15′ of the sensor 15 intersects the target surface 60 for the first time. At this point the device 1 is in its transition state Sₜᵣ, and after that point, the changing distance readings from the sensor 15 will reflect a decrease in the distance between the sensor 15 and the target surface 60.

The decrease in distance will continue to be reflected until a certain point, after which the changing distance readings relating from the sensor 15 will reflect an increase in the distance between the sensor 15 and the target surface 60. The above point is such, at which the line of sight 15′ of the sensor 15 is perpendicular to the target surface 60, and the corresponding orientation of the measuring member 14 with respect to the measuring member 12 defines the measurement state Sₘₑₛ of the device, in which the longitudinal axis 14′ of the measuring member 14 and accordingly its measurement area 14_{M} is parallel to the target surface 60.

A recording of the distance readings relating to both sensors 13 and 15 can be taken by the user using button 23.

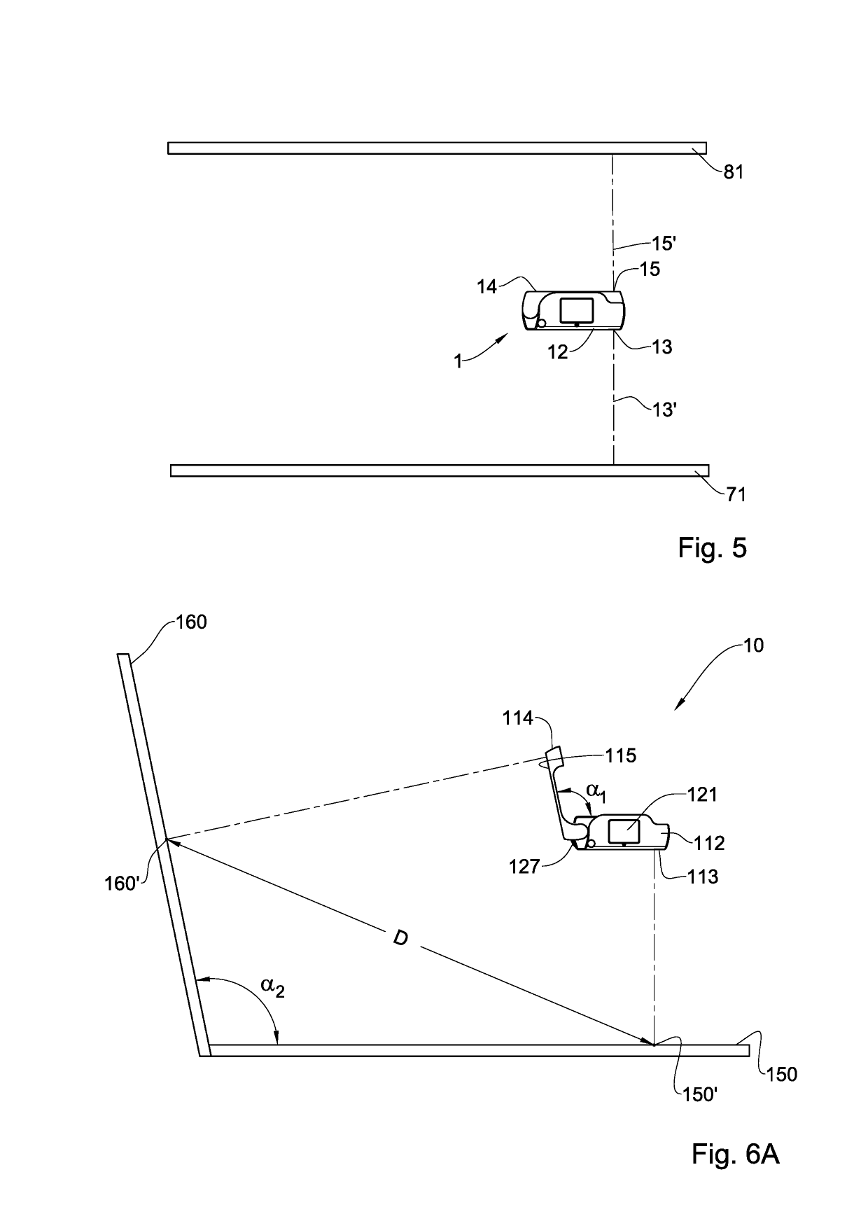

FIG. 5 illustrates an example of using the device 1 with respect to two opposite target surfaces 70 and 80 of respective walls 71 and 81, for such purpose as e.g locating a center line between these two opposite surfaces, i.e. a line disposed at equal distances from the surfaces 70 and 80. In this example, the device 1 is used in its folded state illustrated in FIG. 2B, where the sensors' lines of sight 13′ and 15′ are aligned or parallel, although directed in opposite directions.

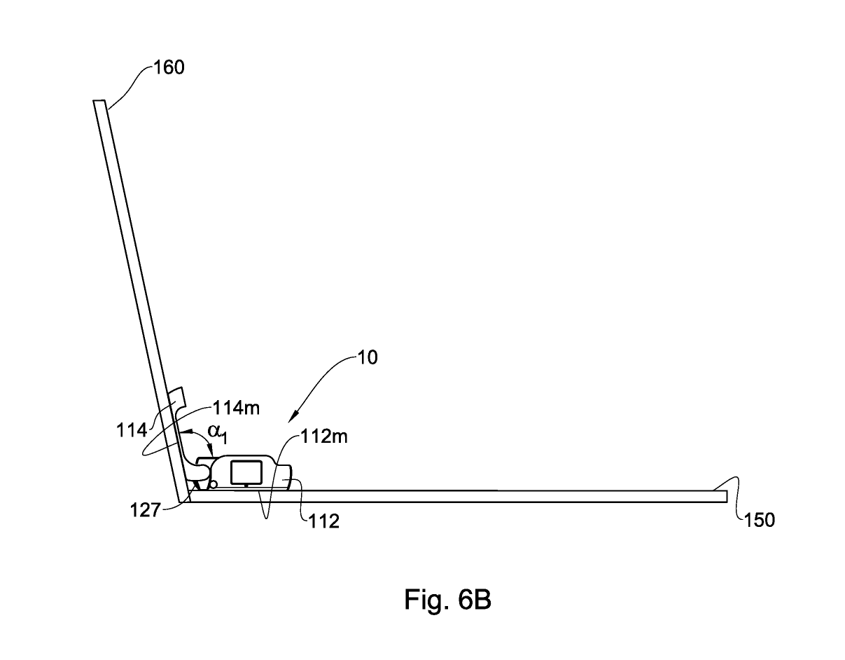

FIG. 6A illustrates an example of a device 10 having the same features and capable of being used in the same manner as the device 1, and further comprising an angle-meter 127, allowing the device to be further used for measuring an angle between two angled surfaces such as target surfaces 150 and 160 of walls 151 and 161. In FIG. 6 the surfaces 150 and 160 are shown to form an obtuse angle therebetween and the device 10 is directed to measure this angle.

Thus, the angle-meter 127 of the device 10 is configured for measuring an angle ∝₁ between its measuring members 112 and 114, and more particularly, between its measurement reference planes. When during the use of the device 10, it is brought into its measurement state Sₘₑₛ, in which its measuring members 112 and 114 are so oriented that their reference planes are parallel to the target surfaces 150 and 160, as described with reference to FIG. 4, an angle ∝₁ between the measuring members 112 and 114 will correspond to an angle ∝₂ between the target surfaces 150 and 160. The corresponding angle reading, indicating the angle between the target surfaces 150 and 160 can be produced alone or together with the readings described above with respect to the device 1, by an indicator of the device 10 such as its display 121.

The angle between the target surfaces 150 and 160 can further be measured directly by positioning the device 10 at the corner of the target surfaces 150 and 160 such that each of its measurement areas 112m and 114m abut a respective target surface 150 and 160, as seen in FIG. 6B.

The angle-meter can further be connected to the processing unit of the device, or the processing unit can receive its angle signals via Bluetooth communication or via wired communication. The processing unit can be configured for receiving both distance signals from sensors 113 and 115, as well as the relative angle signal from the angle-meter 127, and use the system parameters (that can be fed to the processing unit in advance), to actuate simple mathematical computations that are well known to a person skilled in the art, to determine the distance D between the intersection points 150′,160′ of the sensor's lines of sight 13′,15′ and their respective target surfaces 150,160.

This can be useful for measuring the length of an elongated object such as a nearby building.

Using alternative mathematical computations the processing unit can further transform the distance signals received from sensors 113 and 115 to the distance signals that would have been received if the measuring members 112 and 114 were positioned at an angle of 180° in relation to each other, for example using analytic geometry rules.

Any of the devices 1, 10 described above can further comprise a spirit level configured to indicate whether the longitudinal axes of their measuring members are horizontal. The spirit level can be exposed to the user's eyes or integral within one of the measuring members.

Any of the devices 1 and 10 can further comprise a gyrocompass configured for producing a signal indicative of the direction of at least one of the earth's poles, the signal can be processed by the processing unit and be received by the indicator which in turn, can produce a reading related to it.

The devices 1 and 10 are shown in the drawings to have such configuration that in their folded state the footprint of the measuring member 14, 114 in a plan view of the device is substantially completely contained within the footprint of the measuring member 12, 112, resulting in the compactness of the device in the folded state, allowing its use as a pocket held device. However, devices according to the presently disclosed subject matter can clearly have any other configurations and dimensions.

The measurement areas any device according to the presently disclosed subject matter, can be have a geometry, e.g. be sufficiently long, to allow its use as marking flanges.

The processing unit of a device according to the presently disclosed subject matter, can be configured to calculate 2D coordinates of any pre-determined point of the device accessible from its exterior for making a visual marking corresponding to this point on a surface, at which the device is disposed.

A device according to the presently disclosed subject matter, can comprise a marker configured for making visual markings on a surface, at which the device is disposed.

A device according to the presently disclosed subject matter can further comprise a magnometer, configured for detecting metals undersurface, it is purposed for example, for a user intending to drill a hole in a wall and wanting to mark a spot far away from concrete reinforcements.

A device according to the presently disclosed subject matter, can be provided with one or more additional measuring members of the kind described above to allow the device to perform one or more of the above measuring operations with respect to more than two target surfaces. In such device, each pair of adjacent measuring members can function as the measuring members 12 and 14, or 112 and 114 as described above.

Those skilled in the art to which this invention pertains will readily appreciate that numerous changes, variations, and modifications can be made without departing from the scope of the presently disclosed subject matter, mutatis mutandis.

1. A device for measuring at least a distance from one or more target surfaces, said device comprising:
at least two measuring members each having a distal end and a proximal end spaced from each other along a longitudinal axis of the measuring member, said two measuring members being connected to each other so as to be able to perform pivotal movement about a common pivot axis passing through and perpendicular to a pivot plane of each measuring member, in which its longitudinal axis lies in any angular position of the measuring member with respect to the pivot axis, the pivot axis being disposed closer to the proximal ends of the measuring members than to their distal ends; and
at least one distance sensor at each of the two measuring members, positioned so that its line of sight is transverse to a reference plane perpendicular to said pivot plane and passing through said longitudinal axis, said sensor being configured for producing a signal indicative of the distance between the sensor and a target surface;
wherein said device is manipulable by pivoting the measuring members relative to each other about the pivot axis, at least between an open state, in which the reference planes of the two measuring members create therebetween an angle greater than 90°, optionally greater than 150°, and a folded state, in which these reference planes create therebetween an angle smaller than 90°, optionally smaller than 30°.

2. A device according to claim 1, wherein at least one of the sensors is positioned at a location of the measuring member closer to the distal end than to the proximal end of the measuring member.

3. A device according to claim 1, said device further comprises at least one processing unit configured for receiving and processing the signals from the distance sensors of the measuring members, and an indicator configured for producing at least one reading based on the processed signals.

4. A device according to claim 3, wherein said at least one reading relates to the parallelity of at least one target surface to a portion of at least one of the measuring members.

5. A device according to claim 3, wherein said at least one reading relates to the angle between at least one target surface and a second portion of at least one of the measuring members.

6. A device according to claim 3, wherein said at least one reading relates to a spatial location of a pre-determined area on at least one of the measuring members in relation to at least one target surface.

7. A device according to claim 3, wherein said at least one reading relates to the angle between two target surfaces.

8. A device according to claim 3, wherein said at least one reading relates to the distance between two distal points spaced from each other and located on one or two target surfaces.

9. The device according to claim 3, wherein said device further comprises a user interface allowing a user to choose a kind of reading to be produced on said indicator.

10. A device according to claim 9, wherein said reading is visual.

11. A device according to claim 9, wherein said reading is vocal.

12. A device according to claim 1, wherein said device further comprises an angle meter configured for producing a signal indicative of an angle between the reference planes of the two measuring members.

13. A device according to claim 1, wherein said distance sensors are ultrasonic sensors.

14. A device according to claim 1, wherein said distance sensors are laser based sensors.

15. A device according to claim 1, wherein said distance sensors are IR based sensors.

16. A device according to claim 1, wherein said device further comprises a magnometer configured for detecting metals undersurface.

17. A device according to claim 1, wherein said device further comprises a marker configured for marking visual markings upon a rough surface.

18. A device according to claim 1, wherein said device further comprises a spirit level configured to indicate whether the longitudinal axes of the measuring members are horizontal.

19. A device according to claim 1, wherein said device further comprises a gyrocompass configured for producing a signal indicative of a geographic direction of at least one of the earth's poles.

20. A device according to claim 19 further comprising at least one processing unit configured for receiving and processing the signals from the distance sensors of the measuring members, and an indicator configured for producing at least one reading based on the processed signals, wherein said indicator is further configured to produce a reading relating to said geographic direction of at least one of the earth's poles.
